(19) United States
(12) Patent Application Publication
(10) Pub. No.: US 2007/0099063 A1
(43) Pub. Date: May 3, 2007

(54) Solid polymer fuel cell

(75) Inventors: Koudai Yoshizawa, Kanagawa (JP); Hiroshi Miyakubo, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD.

(21) Appl. No.: 10/578,909

(22) PCT Filed: Nov. 2, 2004
(86) PCT No.: PCT/JP04/16616

§ 371 Date: May 12, 2006

(30) Foreign Application Priority Data
Nov. 13, 2003 (JP) 2003-384039

(51) Int. Cl. H01M 8/02

(52) U.S. Cl. 429/39

(57) ABSTRACT

Fuel cells (20) are superimposed one upon the other in the stacking direction. Each fuel cell (20) comprises an anode gas passage (32) and a cathode gas passage (36). Each passage has a meandering configuration provided with two or more bent portions (511, 512, 521, 522). At least the most downstream bent portion (512, 522) of at least one of the anode gas passage (32) and the cathode gas passage (36) is connected to a through-hole (332, 372) extending through the fuel cell stack (1) in the stacking direction of the fuel cells (20). The through hole (332, 372) averages out the condensed water in the anode gas passages (32 )or the cathode gas passages (36) and prevents flooding from being caused in a specific anode gas or cathode gas passage.

### FIELD OF THE INVENTION

This invention relates to separators of a solid polymer fuel cell and a configuration of passages provided therein.

### BACKGROUND OF THE INVENTION

A solid polymer fuel cell stack comprises a plurality of fuel cells stacked together in one direction. Each fuel cell is composed of a membrane electrode assembly and separators sandwiching the membrane electrode assembly. A membrane electrode assembly comprises an electrolyte membrane with an anode and a cathode respectively arranged on either side thereof. The separator in contact with the anode has a passage for an anode gas whose main component is hydrogen, and the separator in contact with the cathode has a passage for a cathode gas containing oxygen.

The fuel cell generates power through electrochemical reaction through the electrolyte membrane between hydrogen supplied to the anode and oxygen supplied to the cathode. To cause this electrochemical reaction, the electrolyte membrane requires a moist condition. Thus, it is desirable to moisten the anode gas and the cathode gas beforehand. On the other hand, as a result of the electrochemical reaction, the fuel cell generates water at the cathode. This water is also re-utilized to moisten the electrolyte membrane.

In each fuel cell, the anode gas flows down through a groove-like passage formed in the separator so as to face the anode. The cathode gas flows down through a groove-like passage formed in the separator so as to face the cathode.

The fuel cell stack is provided with an anode gas supply manifold that distributes an anode gas to each anode gas passage and an anode effluent exhaust manifold that recovers anode effluent exhausted from each anode gas passage, the both manifolds extending through the fuel cells.

Similarly, the fuel cell stack is provided with a cathode gas supply manifold that distributes a cathode gas to each cathode gas passage and a cathode effluent exhaust manifold that recovers cathode effluent exhausted from each cathode gas passage, the both manifolds extending through the fuel cells.

As stated above, as a result of the electrochemical reaction between hydrogen and oxygen, water is generated at the cathode. Part of this water permeates through the cathode to moisten the electrolyte membrane, whereas the rest of the water is discharged from the cathode gas passage to the cathode effluent exhaust manifold as water vapor together with cathode effluent. The more downstream, the larger the amount of water vapor in the cathode gas passage. As a result, water vapor is condensed in the downstream portion of the cathode gas passage to become liquid water, which may hinder the circulation of the cathode gas. When the cathode gas passage has a meandering configuration with portions bent at substantially 180 degrees, the bent portions tend to be subject to flooding. Regarding the anode gas also, when moistening is performed prior to supplying it to the fuel stack, a similar flooding may occur in the anode gas passage.

### SUMMARY OF THE INVENTION

Regarding the prevention of flooding, JP 2000-100458 A and JP 2000-82482 A, published in the year 2000 by the Japan Patent Office, propose forming a through-hole in the fuel cell stack that communicates between the bent portions of the gas passages of the fuel cells. The through-hole helps to attain evenness of water contained in the anode gas and the cathode gas so that the surplus moisture in the cathode gas passages and the anode gas passages may not become excessive in particular fuel cells, which is desirable from the viewpoint of preventing flooding.

In JP 2000-100458 A, in consideration for the arrangement of the manifolds and the through-holes, the flow of the anode gas and the flow of the cathode gas on either side of the membrane electrode assembly are made perpendicular to each other. However, to uniformize water distribution by water movement between the anode and cathode of a fuel cell through the membrane electrode assembly, it is desirable to form the anode gas passage and the cathode gas passage on either side of the membrane electrode assembly so as to be parallel to each other, and, at the same time, cause the anode gas and the cathode gas to flow in opposite directions.

The fuel cell disclosed in JP 2000-82482 A satisfies the above condition regarding the gas flow. However, in this fuel cell, the anode gas supply manifold and the cathode effluent exhaust manifold are arranged so as to be spaced apart from each other. Thus, the portion of the anode gas passage in the vicinity of the inlet thereof, which is mostly liable to cause water shortage, is not superimposed on the portion of the cathode gas passage in the vicinity of the outlet thereof, which is mostly liable to cause flooding. Further, the anode effluent exhaust manifold and the cathode gas supply manifold are spaced apart from each other. Thus, the portion of the anode gas passage in the vicinity of the outlet thereof, which is most subject to flooding, is not superimposed on the portion of the cathode gas passage in the vicinity of the inlet thereof, which is most subject to water shortage. In this way, in this fuel cell, the water movement between the cathode and anode cannot be effected efficiently.

Further, in this fuel cell, in consideration for the arrangement of the manifold and the through-holes, the through-holes are provided in the middle flow portions of the anode gas passage and the cathode gas passage. Thus, in this fuel cell construction, it is difficult to prevent flooding in the downstream portions of the passages, which are most subject to flooding.

It is therefore an object of this invention to uniformize the water distribution in the fuel cell to thereby achieve an improvement in terms of flooding prevention performance.

In order to achieve the above object, this invention provides a fuel cell stack comprising fuel cells effecting power generation upon supply of an anode gas and a cathode gas, each of the fuel cells comprising; an anode separator comprising an anode gas passage which has a meandering configuration with two or more bent portions; a cathode separator comprising a cathode gas passage which has a meandering configuration with bent portions, the number of the bent portions of the cathode gas passage being equal to the number of the bent portions of the anode gas passage, the cathode gas passage and the anode gas passage forming gas flows that are in parallel and in opposite directions to each other; and a through-hole which is provided in a most downstream bent portion in at least one of the anode gas passage and the cathode gas passage, the through-hole allowing movement of moisture through the fuel cells.

The details as well as other features and advantages of this invention are set forth in the remainder of the specification and are shown in the accompanying drawings.

### BRIEF DESCRIPTION OF THE DRAWINGS

FIG. 1 is a schematic diagram of a fuel cell system according to a first embodiment of this invention.

FIG. 2 is a schematic diagram of a fuel cell according to the first embodiment of this invention.

FIGS. 3A and 3B are a plan view of an anode gas and cathode gas separators according to the first embodiment of this invention.

FIG. 4 is a diagram showing water distribution in a cathode gas passage.

FIG. 5 is a diagram showing water distribution in an anode gas passage.

FIGS. 6A and 6B are a plan view of an anode gas and cathode gas separators according to a second embodiment of this invention.

FIGS. 7A and 7B are a plan view of an anode gas and cathode gas separators according to a third embodiment of this invention.

FIGS. 8A and 8B are a plan view of an anode gas and cathode gas separators according to a fourth embodiment of this invention.

FIGS. 9A and 9B are a plan view of an anode gas and cathode gas separators according to a fifth embodiment of this invention.

FIGS. 10A and 10B are a plan view of an anode gas and cathode gas separators according to a sixth embodiment of this invention.

FIGS. 11A and 11B are a plan view of an anode gas and cathode gas separators according to a seventh embodiment of this invention.

FIGS. 12A and 12B are a plan view of a cathode gas passage and LLC passage on a cathode gas separator according to an eighth embodiment of this invention.

### DESCRIPTION OF THE PREFERRED EMBODIMENTS

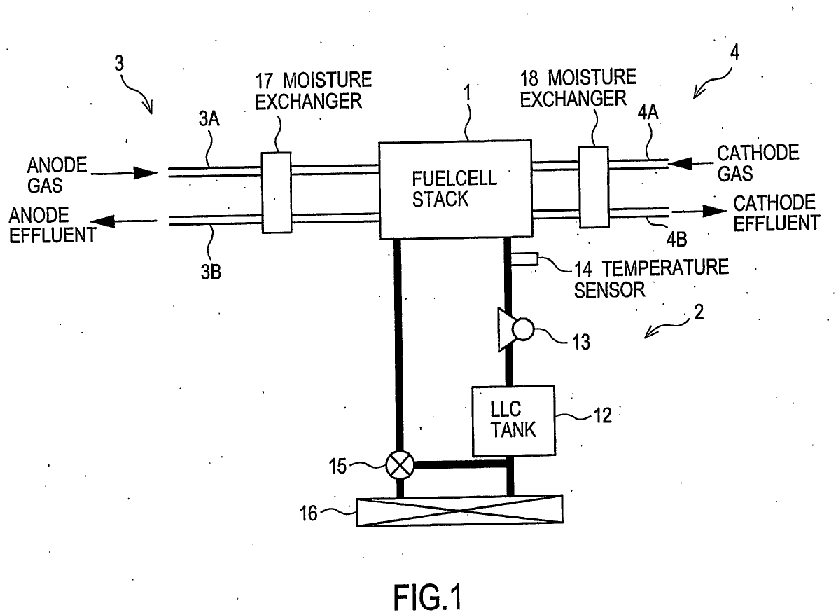

Referring to FIG. 1 of the drawings, a construction of a fuel cell system having a fuel cell stack 1 according to a, first embodiment of this invention will be described.

The fuel cell system comprises a fuel cell stack 1 that generates power through electrochemical reaction between an anode gas containing hydrogen and a cathode gas containing oxygen. Further, the fuel cell system comprises an LLC circulation system 2 that circulates an LLC (long life coolant) as a coolant through the fuel cell stack 1 to thereby keep the fuel cell stack 1 at an appropriate temperature. The LLC circulation system 2 circulates, as the LLC, an antifreeze obtained by mixing ethylene glycol and water with each other. The LLC circulation system 2 comprises an LLC tank 12, an LLC pump 13, a temperature sensor 14, a bypass valve 15, and a radiator 16.

The opening of the bypass valve 15 is controlled according to the output of the temperature sensor 14 to adjust the flow rate of the LLC circulating through the radiator 16. This helps to keep the LLC at a temperature suitable for the cooling of the fuel cell stack 1.

The fuel cell system further comprises an anode gas supply system 3 for supplying the anode gas to the fuel cell stack 1, and a cathode gas supply system 4 for supplying the cathode gas thereto.

The anode gas supply system 3 supplies the anode gas to the fuel cell stack 1 through an anode gas supply passage 3A, and recovers anode effluent from the fuel cell stack 1 through an anode effluent recovery passage 3B. The anode gas supply system 3 comprises a moisture exchanger 17 that moistens the anode gas by using the water contained in the anode effluent.

The cathode gas supply system 4 supplies the cathode gas to the fuel cell stack 1 through a cathode gas supply passage 4A, and recovers cathode effluent from the fuel cell stack 1 through a cathode effluent recovery passage 4B. The cathode gas supply system 4 comprises a moisture exchanger 18 that moistens the cathode gas by using the water contained in the cathode effluent.

It is also possible, for example, to moisten the anode gas by using the moisture of the cathode effluent.

Next, the construction of each fuel cell 20 constituting the fuel cell stack 1 will be described.

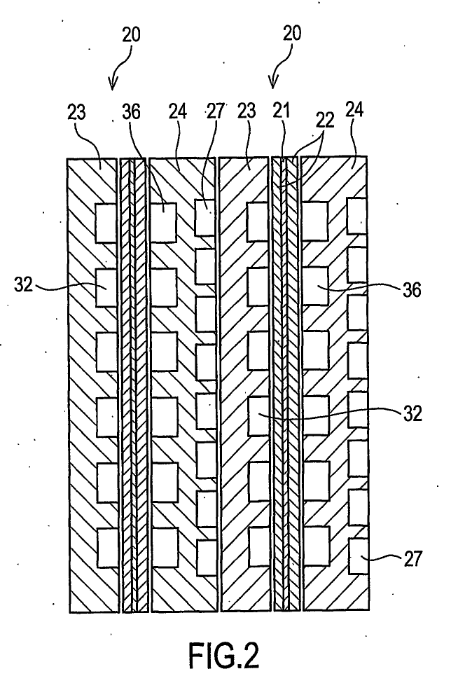

Referring to FIG. 2, the fuel cell 20 comprises a membrane electrode assembly (MEA) 21 formed by an electrolyte membrane with catalyst layers, and gas diffusion layers (GDLs) 22 bonded to either side of the MEA 21. The catalyst layers of the MEA 21 and the GDLs 22 consist of porous materials with pores. It is also possible to integrate the GDLs 22 with the MEA 21.

The fuel cell 20 further comprises an anode separator 23 and a cathode separator 24 sandwiching the GDLs 22 from outside. The anode separator 23 has an anode gas passage 32 facing the anode side GDL 22. The cathode separator 24 has a cathode gas passage 36 facing the cathode side GDL 22. The separator 24 further has a coolant passage (an LLC passage) 27 formed on the side opposite to the cathode gas passage 36 so as to face the adjacent fuel cell 20. It is also possible to provide the LLC passage 27 in the anode separator 23 or provide the LLC passage 27 in both the anode separator 23 and the cathode separator 24.

Next, the configurations of the anode gas passage 32 and the cathode gas passage 36 will be described.

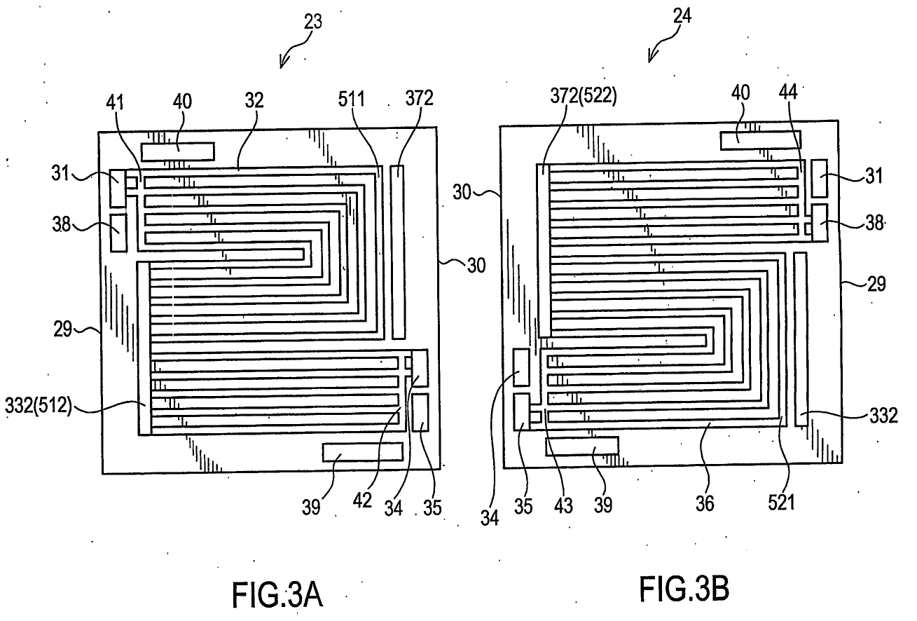

Referring to FIG. 3A, the anode gas passage 32 consists of a plurality of parallel meandering grooves provided in the anode separator 23. Referring to FIG. 3B, the cathode gas passage 36 consists of a plurality of parallel meandering grooves provided in the cathode separator 24. The anode gas passage 32 comprises two bent portions 511 and 512 of substantially 180 degrees. The cathode gas passage 36 comprises two bent portions 521 and 522 of substantially 180 degrees.

The upstream end of the anode gas passage 32 is connected to an anode gas supply manifold 31 through a distributing groove 41. The downstream end of the anode gas passage 32 is connected to an anode effluence exhaust manifold 34 through a recovery groove 42. The anode gas supply manifold 31 and the anode effluent exhaust manifold 34 are passages extending through the fuel cell stack 1 in the direction in which the fuel cells 20 are stacked. The anode gas supply manifold 31 is connected to the anode gas supply passage 3A, and the anode effluent exhaust manifold 34 is connected to the anode effluent recovery passage 3B.

The portions of the anode gas passage 32 between the distributing groove 41 and the bent portion 511, between the bent portions 511 and 512, and between the bent portion 512 and the recovery groove 42 are in the form of a linear groove.

The upstream end of the cathode gas passage 36 is connected to a cathode gas supply manifold 35 through a distributing groove 43. The downstream end of the cathode gas passage 36 is connected to a cathode effluence exhaust manifold 38 through a recovery groove 44. The cathode gas supply manifold 35 and the cathode effluent exhaust manifold 38 are passages extending through the fuel cell stack 1 in the direction in which the fuel cells 20 are stacked. The cathode gas supply manifold 35 is connected to the cathode gas supply passage 4A, and the cathode effluent exhaust manifold 38 is connected to the cathode effluent recovery passage 4B.

The portions of the anode gas passage 36 between the distributing groove 43 and the bent portion 521, between the bent portions 521 and 522, and between the bent portion 522 and the recovery groove 44 are in the form of a linear groove.

The anode gas passage 32 and the cathode gas passage 36 are of the same specifications as much as possible regarding the number of grooves, the groove intervals, the groove width, the length of the linear portions, the configuration and size of the bent portions 511 and 521, and the configuration and size of the bent portions 512 and 522. It should be noted, however, that it is not always necessary for the anode gas passage 32 and the cathode gas passage 36 to be of the same specifications regarding the groove width, the length of the linear portions, the configuration and size of the bent portions 511 and 521, and the configuration and size of the bent portions 512 and 522.

As can be seen from FIG. 3A and FIG. 3B, the separators 23 and 24 are formed in a squares shape of the same size, and the anode gas passage 32 and the cathode gas passage 36 overlap each other in most portions in the stacking direction. Further, as shown in these drawings, the anode gas supply manifold 31 and the cathode effluent exhaust manifold 38 are formed in parallel along a first side 29 of the separators 23 and 24, and the anode effluent exhaust manifold 34 and the cathode gas supply manifold 35 are formed in parallel along a second side 30 opposed to the first side 29 of the separators 23 and 24. Further, the anode gas supply manifold 31 and the cathode effluent exhaust manifold 38 are formed diagonally with respect to the anode effluent exhaust manifold 34 and the cathode gas supply manifold 35.

In other words, the upstream portion of the anode gas passage 32 overlaps the downstream portion of the cathode gas passage 36, and the downstream portion of the anode gas passage 32 overlaps the upstream portion of the cathode gas passage 36. Further, the distributing groove 41 overlaps the recovery groove 44, and the recovery groove 42 overlaps the distributing groove 43, so the portion of the anode gas passage 32 in the vicinity of the inlet thereof overlaps the portion of the cathode gas passage 36 in the vicinity of the outlet thereof, and the portion of the cathode gas passage 36 in the vicinity of the inlet thereof overlaps the portion of the anode gas passage 32 in the vicinity of the outlet thereof. As a result, the flow of anode gas in the anode gas passage 32 is reversed with respect to the flow of cathode gas in the cathode gas passage 36. In the fuel cell 20, the anode gas and the cathode gas circulate in opposite directions in the passage formed in parallel in the linear portions including the portions in the vicinity of the inlets and outlets thereof.

The bent portion 512 on the downstream side of the anode gas passage 32 is connected to a through-hole 332 extending through the fuel cell 20 in the stacking direction. The bent portion 522 on the downstream side of the cathode gas passage 36 is connected to a through-hole 372 extending through the fuel cell 20 in the stacking direction.

The through-hole 332 re-distributes the anode gas distributed to the anode gas passage 32 of each fuel cell 20. At this time, the anode gas is re-distributed not only in a single fuel cell 20, but throughout the anode gas passages 32 of all the fuel cells 20 stacked together. Thus, it is possible to uniformize the amount of water vapor in the anode gas passages 32 over the entire fuel cell stack 1. Similarly, the through-hole 372 uniformizes the amount of water vapor in the cathode gas passages 36 over the entire fuel cell stack 1.

It is also possible to divide the fuel cell stack 1 into a plurality of units, and to form the through-holes 332 and 372 in each unit, thereby uniformizing the amount of water vapor unit by unit.

As can be seen from FIG. 3A and FIG. 3B, the sectional area of the through-hole 332 is larger than the sectional area of each groove forming the anode gas passage 32, and the sectional area of the through-hole 372 is larger than the sectional area of each groove forming the cathode gas passage 36. Thus, if condensed water remains in the through-hole 332, the flow of anode gas is less hindered as compared with the case in which condensed water remains in the anode gas passage 32. Similarly, if condensed water remains in the through-hole 372, the flow of cathode gas is less hindered as compared with the case in which condensed water remains in the cathode gas passage 36.

The bent portion 512, which is situated most downstream and likely to allow condensed water to remain there, is connected to the through-hole 332, so that the condensed water generated in the bent portion 512 remains in the through-hole 332 with a large sectional area. As a result, it is possible to remove the surplus moisture in the anode gas, thereby preventing flooding on the downstream portion of the anode gas passage 32.

Similarly, The bent portion 522, which is situated most downstream and likely to allow condensed water to remain there, is connected to the through-hole 372, so that the condensed water generated in the bent portion 522 remains in the through-hole 372 with a large sectional area. As a result, it is possible to remove the surplus moisture in the cathode gas, thereby preventing flooding on the downstream portion of the cathode gas passage 36.

Further, as can be seen from these drawings, the bent portion 512 of the anode gas passage 32 is situated in the vicinity of the bent portion 521 of the cathode gas passage 36, and the bent portion 522 of the cathode gas passage 36 is situated in the vicinity of the bent portion 511 of the anode gas passage 32. Further, the bent portion 512 is situated on the outer side of the bent portion 521, and the bent portion 522 is situated on the outer side of the bent portion 511.

Due to this construction, the through-hole 332 does not interfere with the bent portion 521, and the through-hole 372 does not interfere with the bent portion 511. Therefore, it is possible to cause the anode gas passage 32 and the cathode gas passage 36 to overlap each other in many portions, thereby moving water between the anode gas passage 32 and the cathode gas passage 36 through the MEA 21 and uniformizing the water distribution inside the fuel cell 20.

The LLC passage 27 communicates with an LLC supply manifold 39 and an LLC exhaust manifold 40. As shown in FIG. 3A and FIG. 3B, both the LLC supply manifold 39 and the LLC exhaust manifold 40 extend through the fuel cell 20 at locations where they do not interfere with the anode gas passage 32 or the cathode gas passage 36.

Next, the water distributing condition inside the fuel cell 20 will be described.

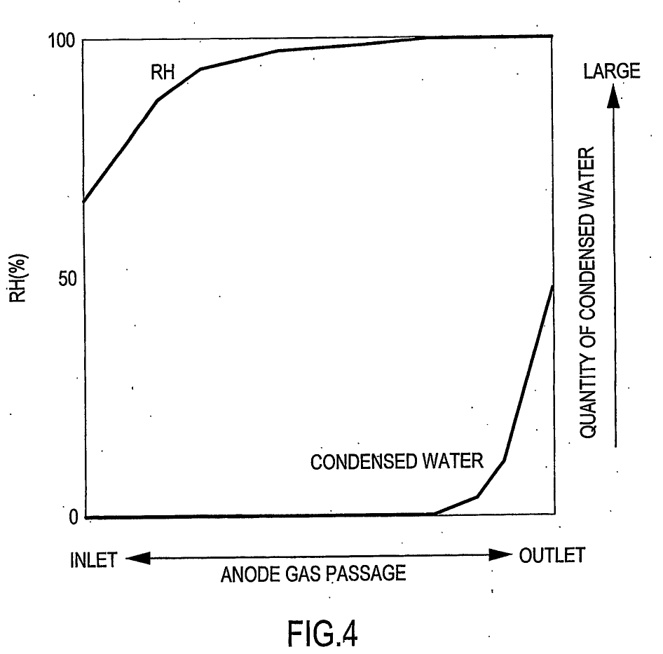

First, referring to FIG. 4, the water distributing condition in the cathode gas passage 36 will be described.

In the cathode gas passage 36, water generated at the cathode is evaporated into the cathode gas from the pores of the cathode side catalyst layer of the MEA21 through the cathode side GDL 22. As a result, the relative humidity (RH) increases along the cathode gas flow, and condensed water is generated in the downstream of the cathode gas passage 36 due to saturation of water vapor.

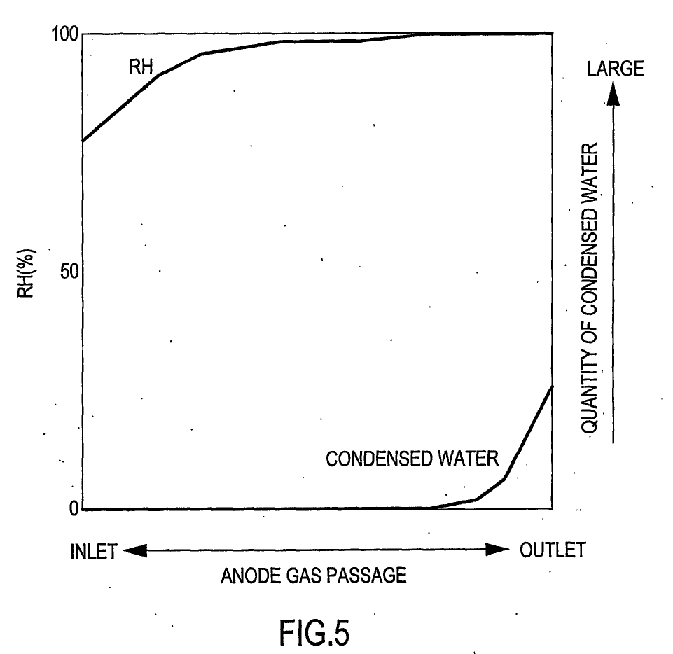

Next, referring to FIG. 5, the water distribution in the anode gas passage 32 will be described. As stated above, the anode gas is moistened beforehand.

Regarding the anode gas passage 32, Water vapor having permeated through the electrolyte membrane of the MEA 21 is mixed with the anode gas through the pores of the anode side catalyst layer of the MEA 21 through the anode side GDL 22. On the other hands, as the electrochemical reaction proceeds, the amount of anode gas greatly decreases. As a result, in the anode gas passage 32 also, the RH of the anode gas increases along the flow, and, on the downstream side of the anode gas passage 32, condensed water due to saturation of water vapor is likely to be generated.

In other words, the RH increases on the respective downstream sides of the anode gas passage 32 and the cathode gas passage 36, and condensed water is likely to be generated. When concentrated on a particular fuel cell 20, and further, when concentrated on a particular groove of the anode gas passage 32 or the cathode gas passage 36, such condensed water leads to flooding.

In this embodiment, condensed water generated in the anode gas remains in the through-hole 332, and liquid water in the vicinity of the outlet of the anode gas passage 32 permeates through the electrolyte membrane to move to the portion in the vicinity of the inlet of the cathode gas passage 36, whereby it is possible to prevent flooding in the anode gas passage 32. Further, condensed water generated in the cathode gas remains in the through-hole 372, and liquid water in the vicinity of the outlet of the cathode gas passage 36 permeates through the electrolyte membrane to move to the portion in the vicinity of the inlet of the anode gas passage 32, whereby it is possible to prevent flooding in the cathode gas passage 36.

Further, throughout the fuel cell stack 1, the through-hole 372 uniformizes the RH in the downstream portions of the cathode gas passages 36, and the through-hole 332 uniformizes the RH in the downstream portions of the anode gas passages 32. Thus, it is possible to prevent flooding due to concentration of condensed water on a particular portion.

It is also possible to set the fuel cell stack 1 such that the fuel cells 20 are stacked in the vertical direction, and to provide, at the lowermost ends in the vertical direction of the through-holes 332 and 372, spaces for recovering condensed water from the through-holes 332 and 372. This helps to prevent the condensed water collected into the through-hole 332 from re-entering the anode gas passage 32, and to prevent the condensed water collected into the through-hole 372 from re-entering the cathode gas passage 36.

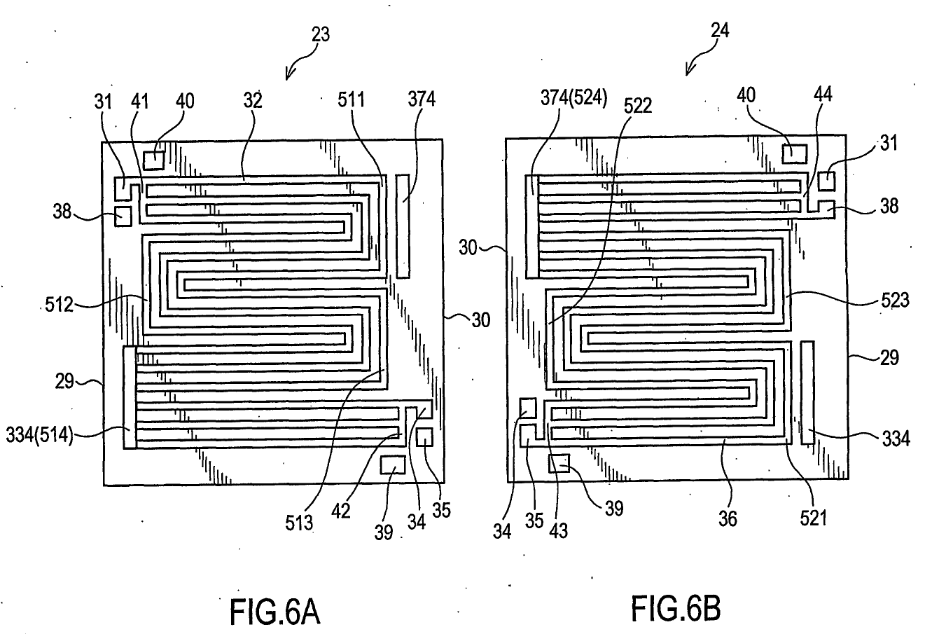

Next, referring to FIG. 6A and FIG. 6B, a second embodiment of this invention will be described. In the second embodiment, the anode gas passage 32 and the cathode gas passage 36 are constructed as follows.

Referring to FIG. 6A, the anode gas passage 32 comprises four bent portions 511, 512, 513, and 514, and five linear portions. The five linear portions are provided between the anode gas supply manifold 31 and the bent portion 511; between the bent portions 511 and 512, 512 and 513, and 513 and 514; and between the bent portion 514 and the anode effluent exhaust manifold 34. Of the bent portions 511 through 514, the bent portion 514 situated most downstream with respect to the anode gas flow is connected to a through-hole 332 extending through the fuel cell stack 1 in the direction in which the fuel cells 20 are stacked together.

Referring to FIG. 6B, the cathode gas passage 36 comprises four bent portions 521, 522, 523, and 524, and five linear portions. The five linear portions are provided between the cathode gas supply manifold 35 and the bent portion 521; between the bent portions 521 and 522, 522 and 523, and 523 and 524; and between the bent portion 524 and the cathode effluent exhaust manifold 38. Of the bent portions 521 through 524, the bent portion 524 situated most downstream with respect to the cathode gas flow is connected to a through-hole 372 extending through the fuel cell stack 1 in the direction in which the fuel cells 20 are stacked together.

The bent portions 512 and 523 overlap each other in the stacking direction, and the bent portions 513 and 522 overlap each other in the stacking direction. The bent portion 514 is situated on the outer side of the bent portion 521, and the bent portion 524 is situated on the outer side of the bent portion 511.

Due to this construction, the through-hole 334 does not interfere with the bent portion 521, and the through-hole 374 does not interfere with the bent portion 511, whereby it is possible to cause the anode gas passage 32 and the cathode gas passage 36 to overlap each other in most portions.

The configurations of the anode gas passage 32 and the cathode gas passage 36 are not restricted to those of the first embodiment and the second embodiment. It is only necessary for the anode gas passage 32 to comprise two or more bent portions 511, 512, . . . including the bent portion 51m situated most downstream, which is connected to the through-hole 33m. Further, it is only necessary for the cathode gas passage 36 to comprise two or more bent portions 521, 522, . . . including the bent portion 52m situated most downstream, which is connected to the through-hole 37n. In this case, it is possible for the anode gas passage 32 and the cathode gas passage 36 to overlap each other in many portions.

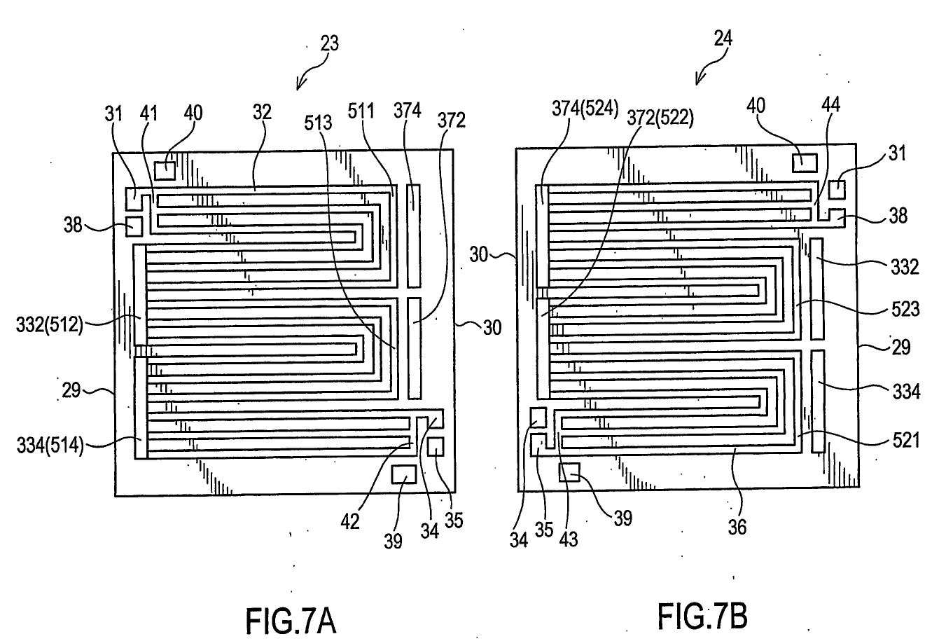

Next, referring to FIG. 7A and FIG. 7B, a third embodiment of this invention will be described. In the third embodiment, the anode gas passage 32 and the cathode gas passage 36 are constructed as follows.

Referring to FIG. 7A, the anode gas passage 32 comprises four bent portions 511, 512, 513, and 514, and five linear portions. Of the bent portions 511 through 514, the bent portion 514 situated most downstream with respect to the anode gas flow is connected to a through-hole 334 extending through the fuel cell stack 1 in the direction in which the fuel cells 20 are stacked together. Further, of the bent portions 511 through 514, an even-numbered bent portion as counted from the inlet side of the anode gas passage 32, in this case the second bent portion 512, is connected to a through-hole 332 extending through the fuel cell stack 1 in the direction in which the fuel cells 20 are stacked together.

Referring to FIG. 7B, the cathode gas passage 36 comprises four bent portions 521, 522, 523, and 524, and five linear portions. Of the bent portions 511 through 514, the bent portion 524 situated most downstream with respect to the cathode gas flow is connected to a through-hole 374 extending through the fuel cell stack 1 in the direction in which the fuel cells 20 are stacked together. Further, of the bent portions 521 through 524, an even-numbered bent portion as counted from the inlet side of the cathode gas passage 36, in this case the second bent portion 522, is connected to a through-hole 372 extending through the fuel cell stack 1 in the direction in which the fuel cells 20 are stacked together.

As can be seen from FIG. 7A and FIG. 7B, the bent portion 512 is arranged on the outer side of the bent portion 523, the bent portion 514 is arranged on the outer side of the bent portion 521, the bent portion 522 is arranged on the outer side of the bent portion 513, and the bent portion 524 is arranged on the outer side of the bent portion 511. Due to this arrangement, the through-hole 332 does not interfere with the bent portion 523, the through-hole 334 does not interfere with the bent portion 521, the through-hole 372 does not interfere with the bent portion 513, and the through-hole 374 does not interfere with the bent portion 511, whereby it is possible to cause the anode gas passage 32 and the cathode gas passage 36 to overlap each other in most portions.

The configurations of the anode gas passage 32 and the cathode gas passage 36 are not restricted to those described above as long as they satisfy the following conditions. The anode gas passage 32 comprises an even number of bent portions 511, 512, . . . , 51m, which are not less than four, and through-holes 33x are connected to an even-numbered bent portions 51x as counted from the inlet side. Further, it is not necessary for all the even-numbered bent portions 51x as counted from the inlet side of the anode gas passage 32 to be connected to the through-holes 33x. It is only necessary to connect, in addition to the bent portion 51m situated most downstream, at least one even-numbered bent portion 51x to the through-hole 33x. This also applies to the cathode gas passage 36.

Due to this construction, it is possible to restrain flooding in the anode gas passage 32 having a number of bent portions 511, 512, . . . and the cathode gas passage 36 having a number of bent portions 521, 522, . . .

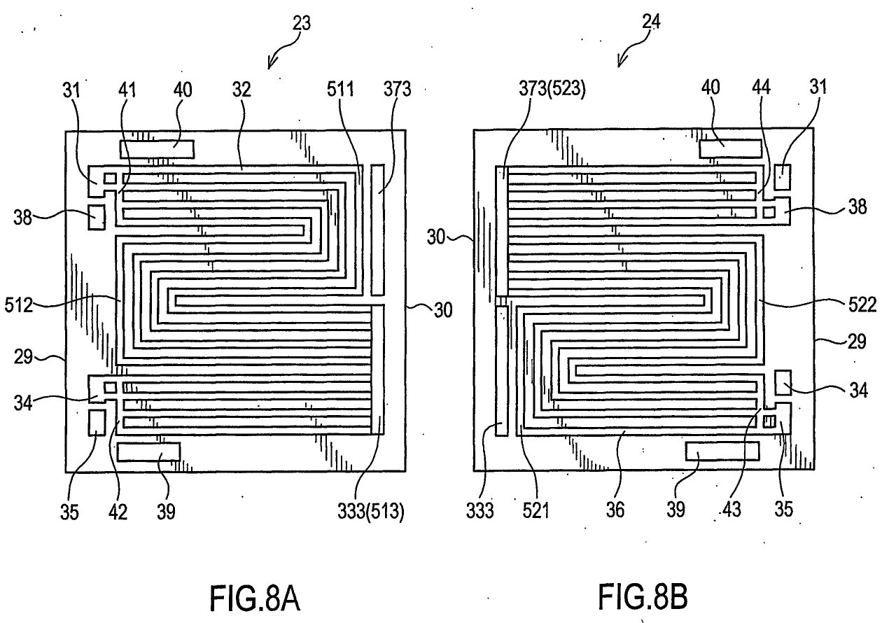

Next, referring to FIG. 8A and FIG. 8B, a fourth embodiment of this invention will be described. In the fourth embodiment, the anode gas passage 32 and the cathode gas passage 36 are constructed as follows.

Referring to FIG. 8A, the anode gas passage 32 comprises three bent portions 511, 512, and 513, and four linear portions. Of the bent portions 511 through 513, the bent portion 513 situated most downstream with respect to the anode gas flow is connected to a through-hole 333 extending through the fuel cell stack 1 in the direction in which the fuel cells 20 are stacked together.

Referring to FIG. 8B, the cathode gas passage 36 comprises three bent portions 521, 522, and 523, and four linear portions. Of the bent portions 521 through 523, the bent portion 523 situated most downstream with respect to the cathode gas flow is connected to a through-hole 373 extending through the fuel cell stack 1 in the direction in which the fuel cells 20 are stacked together.

The bent portions 512 and 522 overlap each other in the stacking direction. The bent portion 513 is situated on the outer side of the bent portion 521, and the bent portion 523 is situated on the outer side of the bent portion 511. Due to this construction, it is possible to cause the anode gas passage 32 and the cathode gas passage 36 to overlap each other in most portions.

Here, the anode gas supply manifold 31 and the cathode effluent exhaust manifold 38 adjacent to each other, and the anode effluent exhaust manifold 34 and the cathode gas supply manifold 35 adjacent to each other, are arranged on the same side with respect to the region where the passages are provided.

The configurations of the anode gas passage 32 and the cathode gas passage 36 are not restricted to those described above. It is only necessary for the anode gas passage 32 to comprise an odd number of bent portions 511, 512, . . . , which are not less than three, with the bent portion 51m situated most downstream being connected to the through-hole 33m. This also applies to the cathode gas passage 36. Here, the anode gas passage 32 and the cathode gas passage 36 are of the same specifications regarding the number of grooves, the groove interval, the groove width, the length of the linear portions, and the configurations and sizes of the bent portions 511 through 51m and 521 through 52m. This makes it possible for the anode separator 23 and the cathode separator 24 to be formed of plates of the same configuration.

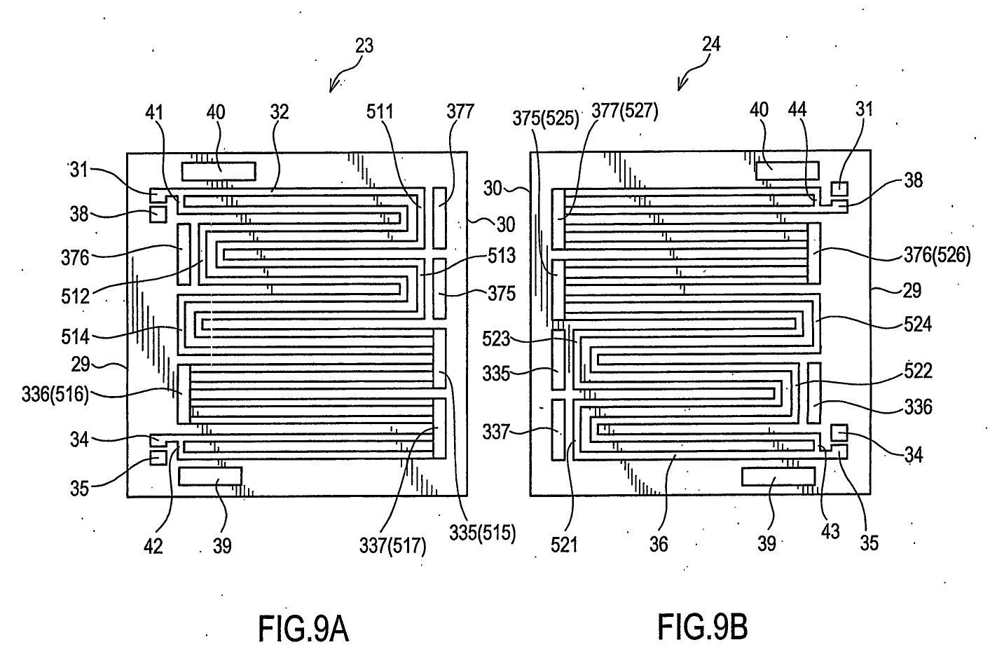

Next, referring to FIG. 9A and FIG. 9B, a fifth embodiment of this invention will be described. In the fifth embodiment, the anode gas passage 32 and the cathode gas passage 36 are constructed as follows.

Referring to FIG. 9A, the anode gas passage 32 comprises seven bent portions 511 through 517, and eight linear portions. Of the bent portions 511 through 517, the bent portion 517 situated most downstream with respect to the anode gas flow is connected to a through-hole 337 extending through the fuel cell stack 1 in the direction in which the fuel cells 20 are stacked together. Further, of the bent portions 511 through 516, the bent portion 515 situated halfway on the downstream side of the anode gas passage 32 is connected to a through-hole 335, and the bent portion 516 situated between the bent portions 515 and 517 is connected to a through-hole 336.

Referring to FIG. 9B, the cathode gas passage 36 comprises seven bent portions 521 through 527, and eight linear portions. Of the bent portions 521 through 527, the bent portion 527 situated most downstream with respect to the anode gas flow is connected to a through-hole 377 extending through the fuel cell stack 1 in the direction in which the fuel cells 20 are stacked together. Further, of the bent portions 521 through 526, the bent portion 525 situated halfway on the downstream side of the cathode gas passage 36 is connected to a through-hole 375, and the bent portion 526 situated between the bent portions 525 and 527 is connected to a through-hole 376.

As can be seen from FIG. 9A and FIG. 9B, the bent portion 515 is arranged on the outer side of the bent portion 523, the bent portion 516 is arranged on the outer side of the bent portion 522, and the bent portion 517 is arranged on the outer side of the bent portion 521. The bent portion 525 is arranged on the outer side of the bent portion 513, the bent portion 526 is arranged on the outer side of the bent portion 512, and the bent portion 527 is arranged on the outer side of the bent portion 511. Due to this arrangement, it is possible to cause the anode gas passage 32 and the cathode gas passage 36 to overlap each other in the stacking direction in most portions.

The configurations of the anode gas passage 32 and the cathode gas passage 36 are not restricted to those described above as long as they satisfy the following conditions.

The anode gas passage 32 comprises an odd number of bent portions 511, 512, . . . , which are not less than five, and through-holes 33z are connected to bent portions 51z situated further downstream than halfway. Further, it is not necessary for all the bent portions 51z situated further downstream than halfway to be connected to the through-holes 33z. It is only necessary to connect, in addition to the bent portion 51m situated most downstream, at least one bent portion 51zto the through-hole 33z. This also applies to the cathode gas passage 36.

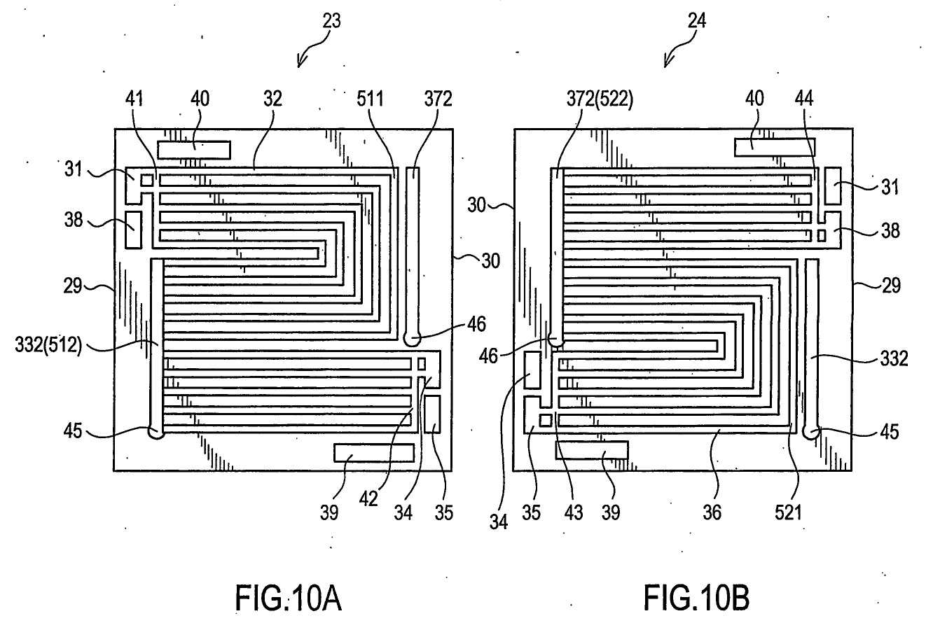

Next, referring to FIG. 10A and FIG. 10B, a sixth embodiment of this invention will be described. In the sixth embodiment, the anode gas passage 32 and the cathode gas passage 36 are constructed as follows.

Referring to FIG. 10A, as in the first embodiment, the anode gas passage 32 comprises two bent portions 511 and 512, and the bent portion 512 on the downstream side is connected to a through-hole 332. In addition, the fuel cell stack 1 comprises a drain manifold 45 which is further connected to the through-hole 332 and consists of a passage extending through the fuel cell stack 1 in the direction in which the fuel cells 20 are stacked together. The drain manifold 45 constitutes a passage that discharges condensed water remaining in the through-hole 332 to the exterior of the fuel cell stack 1. When the fuel cell stack 1 is installed in a working environment, the drain manifold 45 is situated at the lowest part of the through-hole 332.

Referring to FIG. 10B, as in the first embodiment, the cathode gas passage 36 comprises two bent portions 521 and 522, and the bent portion 522 on the downstream side is connected to a through-hole 372. In addition, the fuel cell stack 1 comprises a drain manifold 46 which is further connected to the through-hole 372 and which consists of a passage extending through the fuel cell stack 1 in the direction in which the fuel cells. 20 are stacked together. The drain manifold 46 constitutes a passage that discharges condensed water remaining in the through-hole 372 to the exterior of the fuel cell stack 1. When the fuel cell stack 1 is installed in a working environment, the drain manifold 46 is situated at the lowest part of the through-hole 372.

When the fuel cell stack 1 is not operating, a purge gas is selectively introduced into the drain manifold 45, whereby the water remaining in the through-hole 332 is discharged from the fuel cell stack 1. Further, air is selectively introduced into the drain manifold 46, whereby the water remaining in the through-hole 372 is discharged from the fuel cell stack 1. It is also possible, during operation, to cause anode gas to selectively flow through the drain manifold 45, and to cause cathode gas to selectively flow through the drain manifold 46, thereby discharging remaining water.

Due to this construction, it is possible to prevent condensed water from re-entering the anode gas passage 32 from the through-hole 332, or prevent condensed water from re-entering the cathode gas passage 36 from the through-hole 372, thereby preventing flooding.

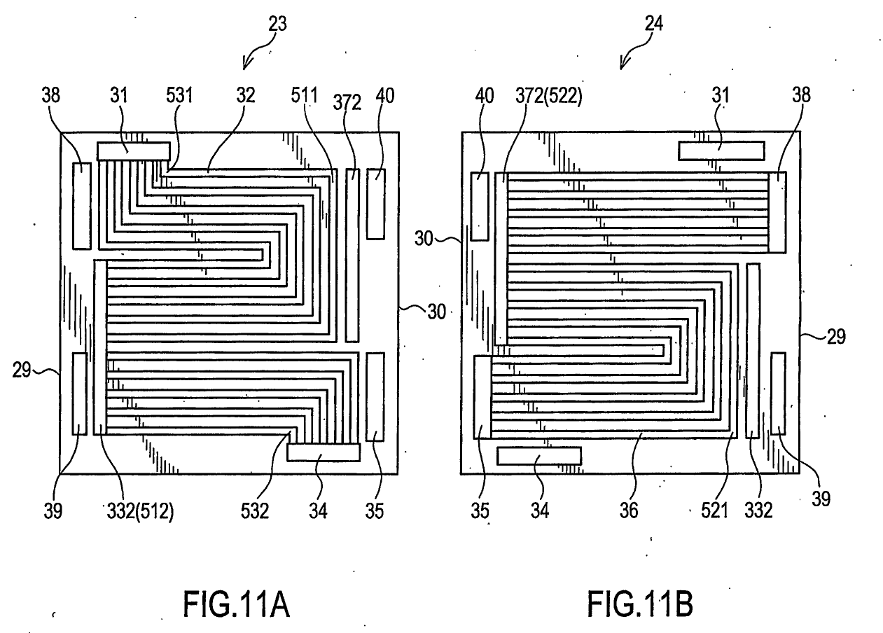

Next, referring to FIG. 11A and FIG. 11B, a seventh embodiment of this invention will be described. In the seventh embodiment, the anode gas passage 32 and the cathode gas passage 36 are constructed as follows.

Referring to FIG. 11A, as in the first embodiment, the anode gas passage 32 comprises two bent portions 511 and 512, with the bent portion 512 on the downstream side being connected to the through-hole 332. The anode gas passage 32 are directly connected to the anode gas supply manifold 31, without any intermediation of the distributing groove 41, and are directly connected to the anode effluent exhaust manifold 34, without any intermediation of the recovery groove 42. In the vicinity of the portion connected to the anode gas supply manifold 31, the anode gas passage 32 comprises a right-angle portion 531 that changes the flowing direction of the anode gas by 90 degrees. Further, in the vicinity of the portion connected to the anode effluent exhaust manifold 34, the anode gas passage 32 comprises a right-angle portion 532 that changes the flowing direction of the anode gas by 90 degrees.

The anode gas supply manifold 31 is arranged at a position attained by rotating the cathode effluent manifold 38 by 90 degrees around the right-angle portion 531, and the anode effluent exhaust manifold 34 is arranged at a position attained by rotating the cathode gas supply manifold 35 by 90 degrees around the right-angle portion 532. Further, as can be seen from FIG. 11A, the entire width of the anode gas passage 32 is substantially equal to the width of the anode gas supply manifold 31 and the width of the anode effluent exhaust manifold 34. Thus, it is possible to diminish the pressure loss when anode gas flows from the anode gas supply manifold 31 to the anode gas passage 32, and the pressure loss when anode gas flows from the anode gas passage 32 to the anode effluent exhaust manifold 34.

Further, the anode gas changes its flowing direction from the horizontal to the vertical direction at the right-angle portion 532 of the anode gas passage 32. The right-angle portion 532 provided in the downstream region of the anode gas passage 32 is subject to generation of condensed water. However, by changing the flowing direction of the anode gas to the vertical direction, condensed water is more easily discharged into the anode effluent exhaust manifold 34.

Further, referring to FIG. 11B, as in the first embodiment, the cathode gas flow passage 36 comprises two bent portions 521 and 522, with the bent potion 522 on the downstream side being connected to the through-hole 372. The entire width of the cathode gas passage 36 is substantially equal to the width of the cathode gas supply manifold 35 and the width of the cathode effluent exhaust manifold 38. Accordingly, it is possible to diminish the pressure loss when cathode gas is supplied from the cathode gas supply manifold 35 to the cathode gas passage 36, and the pressure loss when cathode gas is discharged from the cathode gas passage 36 to the cathode effluent exhaust manifold 38.

Instead of the anode gas passage 32, the cathode gas passage 36 may comprise the right-angle portions 531 and 532.

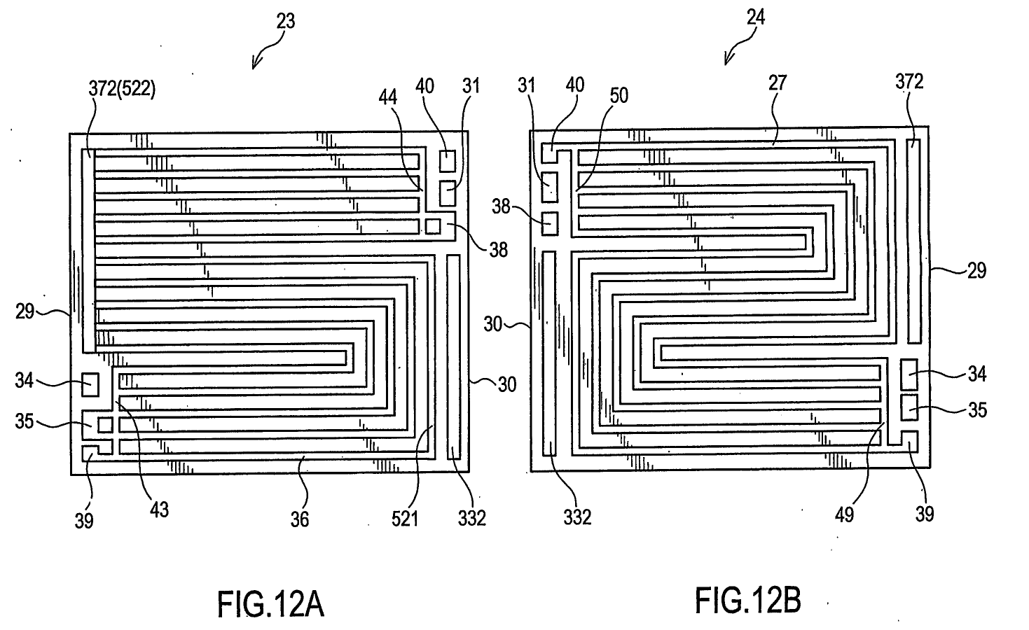

Next, referring to FIG. 12A and FIG. 12B, an eighth embodiment of this invention will be described. In the eighth embodiment, the cathode gas passage 36, anode gas passage 32 and LLC passage 27 are constructed as follows.

Referring to FIG. 12A, the cathode gas passage 36 is constructed in the same manner as in the first embodiment. The anode gas passage 32 is formed in the same configuration as in the first embodiment. It should be noted, however, that the width of the cathode gas supply manifold 35 and the width of the cathode effluent exhaust manifold 38 are smaller than those in the first embodiment. Further, the width of the anode gas supply manifold 31 and the width of the anode effluent exhaust manifold 34 are smaller than those in the first embodiment.

An LLC supply manifold 39 is aligned with the anode effluent exhaust manifold 34 and the cathode gas supply manifold 35, and an LLC exhaust manifold 40 is aligned with the anode gas supply manifold 31 and the cathode effluent exhaust manifold 38.

Referring to FIG. 12B, the LLC passage 27 is of the same configuration as the cathode gas passage 36. In other words, the LLC passage 27 is formed as meandering grooves comprising two bent portions substantially at 180 degrees. The LLC passage 27 overlap the anode gas passage 32 and the cathode gas passage 36 in many portions with respect to the stacking direction. It should be noted, however, that the bent portions of the LLC passage 27 are not connected to the through-hole, but are formed by grooves provided in the surface of the cathode separator 24.

The LLC circulating through the LLC circulation system 2 is supplied to the LLC supply manifold 39, and is distributed to the fuel cells 20. In each fuel cell 20, LLC is distributed to the grooves of the LLC passage 27 through the distributing groove 49. The LLC undergoes heat exchange with the fuel cell 20 in the LLC passage 27, and is recovered through the recovery groove 50 to the LLC exhaust manifold 40 before being discharged from the fuel cell stack 1.

At this time, the LLC flows in the LLC passage 27 in a direction opposite to the flowing direction of the anode gas, and in the same direction as the cathode gas. As a result of the heat exchange between the LLC and the fuel cell 20, the temperature of the LLC gradually increases as it flows downstream through the LLC passage 27, so the temperature of the cathode gas gradually increases as it flows downstream through the cathode gas passage 36. As a result, in the cathode gas passage 36, the amount of water that can be contained by the cathode gas is larger in the downstream portion, thereby making it possible to restrain flooding.

The contents of Tokugan 2003-384039 with filing data of Nov. 13, 2003 in Japan are hereby incorporated by reference.

Although the invention has been described above by reference to certain embodiments of the invention, the invention is not limited to the embodiments described above. Modifications and variation of the embodiments described above will occur to those skilled in the air, within the scope of the claims.

While in FIG. 3 and FIGS. 6A through 12B the number of grooves forming the anode gas passage 32 and the cathode gas passage 36 ranges from 2 to 5, it is also possible for the passages to be formed by a larger number of grooves.

Further, while in FIG. 3 and FIGS. 6A through 12B both the anode gas passage 32 and the cathode gas passage 36 comprise through-holes, it is also possible for such a through-hole to be provided solely for one category of passage.

### INDUSTRIAL FIELD OF APPLICATION

This invention, which relates to water management in a fuel cell system, provides a particularly desirable effect when applied to a vehicle-mounted fuel cell system, which is subject to great fluctuations in load.

The embodiment of this invention in which an exclusive property or privilege is claims are defined as follow:

1-8. (canceled)

9. A fuel cell stack, comprising:
fuel cells effecting power generation upon supply of an anode gas and a cathode gas, each of the fuel cells comprising;
an anode separator comprising an anode gas passage which has a meandering configuration with two or more bent portions;
a cathode separator comprising a cathode gas passage which has a meandering configuration with bent portions, the number of the bent portions of the cathode gas passage being equal to the number of the bent portions of the anode gas passage, the cathode gas passage and the anode gas passage forming gas flows that are in parallel and in opposite directions to each other; and
a through-hole which is provided in a most downstream bent portion in at least one of the anode gas passage and the cathode gas passage, the through-hole allowing movement of moisture through the fuel cells.

2. The fuel cell stack as defined in claim 9, wherein the fuel cell stack has a square shape cross-section and further comprises an anode gas supply manifold which supplies the anode gas to the anode gas passage of each fuel cell;
an anode effluent exhaust manifold which recovers an anode effluent from the anode gas passage of each fuel cell, the anode effluent exhaust manifold being arranged diagonally with respect to the anode gas supply manifold in the cross-section of the fuel stack;
a cathode gas supply manifold which supplies a cathode gas to the cathode gas passage of each fuel cell;
a cathode effluent exhaust manifold which recovers cathode effluent from the cathode gas passage of each fuel cell, the cathode effluent exhaust manifold being arranged diagonally with respect to the cathode gas supply manifold in the cross-section of the fuel cell stack;
wherein the anode gas supply manifold and the cathode effluent exhaust manifold are arranged in parallel along a first side of the stacking surface of the fuel cell, while the anode effluent exhaust manifold and the cathode gas supply manifold are arranged in parallel along a second side, which is opposed to the first side with respect to the cross-section of the fuel cell stack.

11. The fuel cell stack as defined in claim 9, wherein the anode gas passage and the cathode gas passage respectively comprise an even number of bent portions, the number being four or more, and wherein, in addition to the most downstream bent portion, at least one of even-numbered bent portions as counted from an inlet side, other than the most downstream bent portion, comprises a through-hole which allows movement of moisture through the fuel cells.

12. The fuel cell stack as defined in claim 9, wherein the anode gas passage and the cathode gas passage respectively comprise an odd number of bent portions.

13. The fuel cell stack as defined in claim 12, wherein the odd number is five or more, and wherein, in addition to the most downstream bent portion, at least one of bent portions situated halfway on the downstream side, other than the most downstream bent portion, comprises a through-hole which allows movement of moisture through the fuel cells.

14. The fuel cell stack as defined in claim 9, wherein the fuel stack further comprises a drain manifold which drains water in the through-hole to outside of the fuel cell stack.

15. The fuel cell stack as defined in claim 9, wherein, adjacent fuel cells are provided with an LLC passage therebetween which is substantially superimposed in a stacking direction on the cathode gas passage and through which a coolant flows in the same direction as a cathode gas that flows in the cathode gas passage.

16. The fuel cell stack as defined in claim 15, wherein the fuel cell stack comprises supply manifolds that respectively distribute the anode gas, the cathode gas, and the coolant to the fuel cells, and exhaust manifolds that respectively recover an anode gas, a cathode gas, and a coolant from the fuel cells, and wherein the anode gas supply manifold, the cathode gas exhaust manifold and the coolant exhaust manifold are located in the vicinity with respect to each other, while the anode gas exhaust manifold, the cathode gas supply manifold and the coolant supply manifold are located in the vicinity with respect to each other.
